(19) United States
(12) Patent Application Publication
(10) Pub. No.: US 2003/0103627 A1
(43) Pub. Date: Jun. 5, 2003

(54) Method and apparatus for providing parental control

(76) Inventors: Mark Alan Nierzwick, Brownsburg, IN (US); Roy Earl Kidd, Clayton, IN (US)

Correspondence Address: JOSEPH S. TRIPOLI, THOMSON MULTIMEDIA LICENSING INC., 2 INDEPENDENCE WAY, P.O. BOX 5312, PRINCETON, NJ, 08543-5312, US

(21) Appl. No.: 10/004,720

(22) Filed: Dec. 3, 2001

(51) Int. Cl. H04N 7/167

(52) U.S. Cl. 380/240; 725/30

(57) ABSTRACT

A method for operating an apparatus having parental controls includes steps of providing access to the parental controls of the apparatus, determining whether at least one setting of the parental controls is changed during the access, and providing a notification to a user when at least one setting of the parental controls is changed during the access. According to an exemplary embodiment, the notification is provided to the user via an electronic mail message and/or is provided via a message stored in a memory of the apparatus which is retrievable by the user.

### BACKGROUND OF THE INVENTION

1. Field of the Invention

The present invention generally relates to parental control for devices such as a television signal receiver, and more particularly, to a parental control scheme which provides, among other things, notification when parental control settings of a device have been changed.

2. Background Information

Parental control functions are currently available for devices such as a television signal receiver. In fact, certain television signal receivers are required by law to provide parental control functionality, which is often referred to as a “V-Chip.”

In general, parental control functions allow parents to establish program content settings wherein programs having content ratings that exceed the established settings are blocked from viewing. Such functionality may be utilized by parents to prevent their children from viewing inappropriate programs.

Current parental control schemes typically require a user to input a predetermined password before accessing the parental controls to establish or change content settings. This password may, for example, be a multiple digit numeric code (e.g., 1-2-3-4). In an effort to change content settings and thereby watch certain programs, some children may attempt to discover the password without their parents' knowledge. For example, a particularly determined child may attempt to learn the password and thereby circumvent the parental control function by systematically inputting all of the various password combinations until the password is discovered.

To counter unauthorized password discovery, current parental control schemes also provide a means for resetting the password. This enables parents to change the password in the event that a child learns the password, or the parent forgets the password. However, if a child learns the method for resetting the password, the parental control function may likewise be circumvented. Accordingly, in order to improve its reliability and effectiveness, it is desirable for a parental control function to provide, among other things, notification when parental control settings have been changed. The present invention addresses these and other issues.

### SUMMARY OF THE INVENTION

In accordance with an aspect of the present invention, a method for operating an apparatus having parental controls is provided. The method includes steps of providing access to the parental controls of the apparatus, determining whether at least one setting of the parental controls is changed during the access, and providing a notification to a user when at least one setting of the parental controls is changed during the access. According to an exemplary embodiment, the notification is provided to the user via an electronic mail message and/or is provided via a message stored in a memory of the apparatus which is retrievable by the user.

According to another aspect of the present invention, another method for operating an apparatus having parental controls is provided. The method includes steps of detecting when a rating level corresponding to a reproduction exceeds a rating level corresponding to a parental control setting, and providing a notification to a user without blocking the reproduction when the rating level corresponding to the reproduction exceeds the rating level corresponding to the parental control setting. According to an exemplary embodiment, the notification is provided to the user via an electronic mail message and/or is provided via a message stored in a memory of the apparatus which is retrievable by the user.

### BRIEF DESCRIPTION OF THE DRAWINGS

The above-mentioned and other features and advantages of this invention, and the manner of attaining them, will become more apparent and the invention will be better understood by reference to the following description of embodiments of the invention taken in conjunction with the accompanying drawings, wherein:

FIG. 1 is a diagram of an exemplary apparatus suitable for implementing the present invention;

FIG. 2 is a flowchart illustrating exemplary steps according to an aspect of the present invention; and

FIG. 3 is a flowchart illustrating exemplary steps according to another aspect of the present invention.

The exemplifications set out herein illustrate preferred embodiments of the invention, and such exemplifications are not to be construed as limiting the scope of the invention in any manner.

### DESCRIPTION OF THE PREFERRED EMBODIMENTS

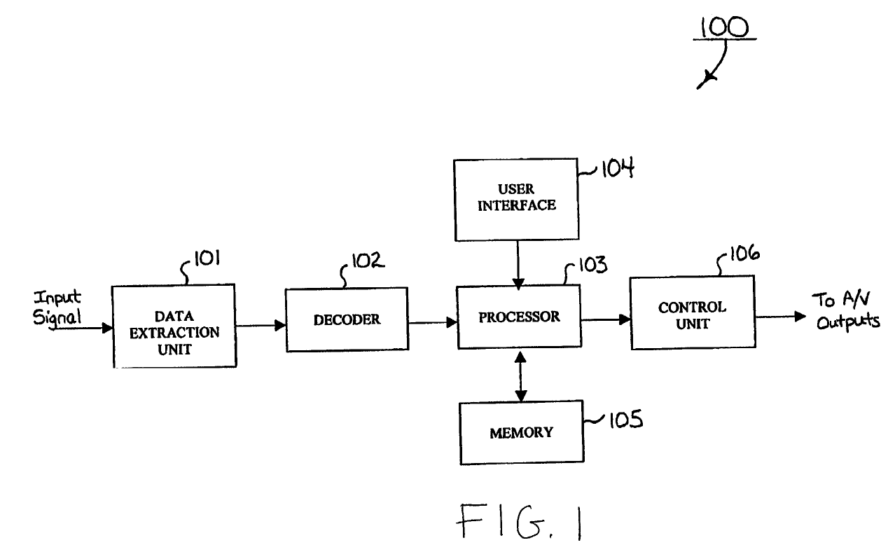

Referring now to the drawings, and more particularly to FIG. 1, a diagram of an exemplary apparatus 100 suitable for implementing the present invention is shown. For purposes of example and explanation, the apparatus 100 of FIG. 1 is shown as a relevant portion of a television signal receiver. However, the principles of the present invention may also be applied to other devices having a parental control function.

The apparatus 100 of FIG. 1 includes a data extraction unit 101, a decoder 102, a processor 103, a user interface 104, a memory 105 and a control unit 106. In operation, an input signal such as a television signal including data representative of its video and/or audio content is provided to the apparatus 100. The data extraction unit 101 receives the input signal and extracts the portion of the data within the input signal representative of its video and/or audio content. For example, in an analog television embodiment, the data extraction unit 101 may extract data from line 21 of the vertical blanking interval (VBI) consistent with specifications such as the EIA-608 specification. Alternatively, in a digital television embodiment, the data extraction unit 101 may extract one or more packets of digital data.

The decoder 102 receives the data extracted by the data extraction unit 101 and decodes the same to generate decoded data representing the video and/or audio content of the input signal. According to an exemplary embodiment, the decoder 102 performs operations including a decoding operation consistent with the extended data services (XDS) specification.

The processor 103 receives decoded data provided by the decoder 102 and performs a processing operation thereon. According to an exemplary embodiment, the processor 103 performs functions including parental control processing functions based on inputs provided via the user interface 104. According to an aspect of the present invention, the processor 103 compares parental control settings (e.g., program ratings) established by a user against the decoded data provided by the decoder 102 to determine whether video and/or audio blocking should be performed. According to another aspect of the present invention, the processor 103 detects, among other things, when the parental control settings of the apparatus 100 have been changed, and provides a notification of such change(s) to a user. As will be discussed later herein, this notification may be provided in one or more different ways, such as via an electronic mail message or other means, such as by automatically communicating with a pager and/or telephone (e.g., automatically dialing the pager or telephone via a modem included in the system). Although not expressly shown in FIG. 1, the processor 103 preferably includes an external communication link such as a telephone line, cable or other link to enable transmission of electronic mail message notifications.

The user interface 104 may be embodied as any type of suitable input terminal, such as a hand-held remote control unit or other input means, which provides inputs to the processor 103. The memory 105 is preferably embodied as a non-volatile memory such as an electrically erasable, programmable, read-only memory (EEPROM). Although shown in FIG. 1 as a separate component, the memory 105 can alternatively be embodied within the processor 103. The memory 105 stores, among other things, data representative of the established parental control settings and other related data.

The control unit 106 receives processed outputs generated by the processor 103 and performs operations including a control operation to selectively block video and/or audio (A/V) outputs of the apparatus 100. This is often referred to as a “V-Chip” function, and is known in the art.

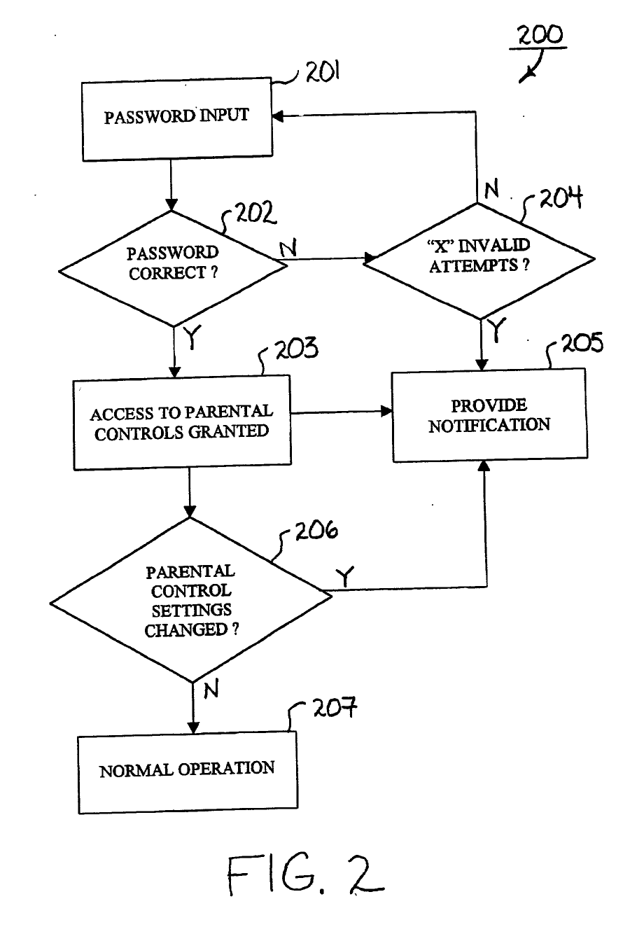

Referring now to FIG. 2, a flowchart 200 illustrating exemplary steps according to an aspect of the present invention is shown. For purposes of example and explanation, the flowchart 200 of FIG. 2 will be described in relation to the apparatus 100 of FIG. 1.

In FIG. 2, process flow begins at step 201 where a user inputs a password via the user interface 104 thereby requesting access to the parental control settings or to temporarily disable parental controls of the apparatus 100. At step 202, the processor 103 receives the input password and determines whether the password is correct. That is, the processor 103 determines whether the input password corresponds to a currently established password, which according to an exemplary embodiment is a multi-character code (e.g., numeric and/or alphabetic) stored in the memory 105. The password may be initially defined during manufacture of the apparatus 100 and/or later defined by a user via the user interface 104.

If the processor 103 determines at step 202 that the password input at step 201 is correct, then process flow advances to step 203 where the processor 103 grants the user access to the parental control settings of the apparatus 100. Once access is granted, the user may define and/or change one or more parental control settings of the apparatus 100 or unblock the program content for viewing. According to an exemplary embodiment, the parental control settings include rating levels such as those specified by EIA-744 or other specifications which are compared against the rating levels of the input signal to the apparatus 100 to determine whether signal blocking is performed. The parental control settings may also allow a user to define and/or change other data elements such as the password, the user's electronic mail address and other data. However, according to an alternative embodiment, the user's electronic mail address (and/or other information (e.g., pager and/or telephone numbers) related to user notification of parental control setting changes) is fixed upon device set up and can not be changed through access to the parental control settings. As will be discussed later herein, the user's electronic mail address is designated to automatically receive certain messages that provide user notification regarding matters such as changes to the parental control settings. Such notification may also be provided to the user via a message stored in the memory 105 which may be retrieved during access to the parental control settings.

Referring back to step 202, if the processor 103 determines that the password input at step 201 is not correct, then process flow advances to step 204 where the processor 103 determines whether “X” number of invalid password input attempts have been made. Here, “X” is a predetermined integer value which may be established at manufacture, and/or later changed by a user through access to the parental controls of the apparatus 100. If the processor 103 determines at step 204 that “X” number of invalid password input attempts have not been attempted, then process flow loops back to step 201 where the user may input another password.

Alternatively, if the processor 103 determines at step 204 that “X” number of invalid password input attempts have been attempted, then process flow advances to step 205 where the processor 103 provides a user notification indicating that “X” number of invalid password input attempts have been made. This notification may be provided in one or more different ways. According to an exemplary embodiment, a user may be notified via an electronic mail message that is automatically sent by the processor 103 to the electronic mail address established during access to the parental control settings. For example, the electronic mail message may state: “X number of invalid password input attempts were made on Oct. 31, 1999.” Alternatively, the system may automatically dial a telephone or pager number using a modem included in the system and deliver the notification to a pager display and/or to the entity answering the telephone (e.g., using voice synthesis technology).

Alternatively, or in addition to the notification by an electronic mail message, the processor 103 may cause a display terminal (not expressly shown in FIG. 1) of the apparatus 100 to display the same or similar message. According to an exemplary embodiment, when the message is provided via the display terminal of the apparatus 100, the message remains displayed until a user (e.g., parent) correctly inputs the current password, or until a predetermined time period has elapsed thereby preventing screen burn. The message could also be displayed as part of normal status displays, for example, as an icon informing the parent to check for messages. According to an exemplary embodiment, the maximum allowable number of invalid password input attempts for a given time period may be defined by a user through access to the parental controls. For example, the apparatus 100 may be programmed to allow up to three invalid password input attempts per day. In this case, if more than three invalid password input attempts are made in a given day, access to the parental controls may be completely locked out until the next day and/or an error message may be generated by any of the previously described methods.

Referring back to step 203 of FIG. 2, after the user is granted access to the parental control functions of the apparatus 100, process flow advances to step 206 where the processor 103 determines whether any of the parental control settings of the apparatus 100 have been changed during access. If the processor 103 determines at step 206 that no change to the parental control settings has been made, then process flow advances to step 207 where the apparatus 100 proceeds with normal operation.

Alternatively, if the processor 103 determines at step 206 that a change to the parental control settings has been made, then process flow loops to step 205 where a user notification to this effect is provided. This notification may be provided in one or more different ways. According to an exemplary embodiment, a user may be notified via an electronic mail message that is automatically sent by the processor 103 to the electronic mail address established during access to the parental control settings. For example, the electronic mail message may state: “Your password for parental control access was changed on Oct. 31, 1999 at 11:01 pm.” Similarly, and by way of further example, the electronic mail message may also state: “Your electronic mail address for receiving notifications concerning changes to parental control settings was changed on Oct. 31, 1999 at 11:02 pm” and/or “Your parental control settings were changed on Oct. 31, 1999 at 11:03 pm to permit viewing of TV-MA programs.” Moreover, the message may also indicate how many times any of the parental control settings including the password, the electronic mail address and other settings have been changed within a given time period. For example, the message may state: “Your parental control settings have been changed four times since Jun. 30, 1999.” Of course, other messages may be provided in accordance with principles of the present invention. Also, if the electronic mail address is changed (assuming this is allowed), an electronic mail message may be sent to both the old and new addresses.

Alternatively, or in addition to, the notification by an electronic mail message or other notification delivery means (e.g., automatically sending a pager or telephone message), the processor 103 may store in the memory 105 the message indicating that the parental control settings have been changed. In this manner, a user (i.e., parent) may check the message by accessing the parental control settings of the apparatus 100. According to an exemplary embodiment, data provided in any message (electronic mail or otherwise) such as the time, date and/or counter stamps indicating when and how many times the parental control settings have been changed can not be altered or reset by a user, even through access to the parental control settings of the apparatus 100.

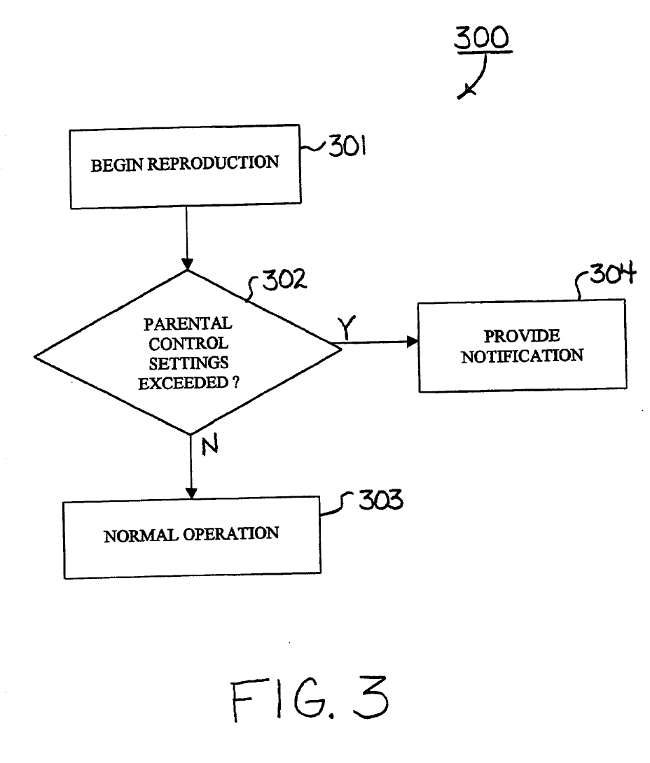

Referring to FIG. 3, a flowchart 300 illustrating exemplary steps according to another aspect of the present invention is shown. For purposes of example and explanation, the flowchart 300 of FIG. 3 will be described in relation to the apparatus 100 of FIG. 1. The steps of FIG. 3 may, for example, be useful in a situation where a parent desires to keep track of the television programs and/or other reproductions perceived by a child, but does not wish to implement any video and/or audio blocking. In this manner, a parent may, for example, determine whether a child is obeying the parents' instructions regarding the types of television programs and/or other reproductions the child is permitted to watch and/or listen to.

In FIG. 3, process flow begins at step 301 where the apparatus 100 begins a video and/or audio reproduction such as a television program or other reproduction. At step 302, the processor 103 detects the rating level(s) of the reproduction, and determines whether the detected rating level(s) exceed any of the rating level(s) represented by the current parental control settings.

If, at step 302, the rating level(s) of the reproduction does not exceed the rating level(s) represented by the current parental control settings, process flow advances to step 303 where the apparatus 100 proceeds accordingly with normal operation. Alternatively, in the event that the rating level(s) of the reproduction exceeds the rating level(s) represented by the current parental control settings, process flow advances to step 304 where, instead of conventional video and/or audio blocking, a user notification is provided. This notification may be provided in one or more different ways. According to an exemplary embodiment, a user may be notified via an electronic mail message that is automatically sent under control of the processor 103 to the electronic mail address established during access to the parental control settings. For example, the electronic mail message may state: “The program ‘Naughty Nurses,’ rated TV-MA, was viewed on Aug. 18, 1999 for 27 minutes beginning at 11:32 pm on channel 19.”

Alternatively, or in addition to the notification by an electronic mail message and/or providing the notification via other means, such as automatic pager or telephone messaging, the processor 103 may store in the memory 105 the message describing the reproduction that exceeds the rating level(s) represented by the current parental control settings. In this manner, a user (i.e., parent) may obtain the message by accessing the parental control settings of the apparatus 100.

Although the present invention has been described in relation to a television signal receiver, the invention is applicable to various systems, either with or without display devices, and the phrase “television signal receiver” as used herein is intended to encompass various types of apparatuses and systems including, but not limited to, television sets or monitors that include a display device, and systems or apparatuses such as a set-top box, video tape recorder (VTR), digital versatile disk (DVD) player, video game box, or personal video recorder (PVR) that may not include display devices.

While this invention has been described as having a preferred design, the present invention can be further modified within the spirit and scope of this disclosure. This application is therefore intended to cover any variations, uses, or adaptations of the invention using its general principles. Further, this application is intended to cover such departures from the present disclosure as come within known or customary practice in the art to which this invention pertains and which fall within the limits of the appended claims.

What is claimed is:

1. A method for operating an apparatus having parental controls, comprising steps of:
providing access to the parental controls of the apparatus;
determining whether at least one setting of the parental controls is changed during the access; and
providing a notification to a user when at least one setting of the parental controls is changed during the access.

2. The method of claim 1, wherein the notification is provided to the user via an electronic mail message.

3. The method of claim 2, wherein the electronic mail message is sent to a predetermined electronic mail address which can not be changed through access to the parental controls.

4. The method of claim 1, wherein the notification is provided via a message stored in a memory of the apparatus which is retrievable by the user.

5. The method of claim 1, wherein the notification indicates a date when the at least one setting of the parental controls is changed.

6. The method of claim 5, wherein the date indicated in the notification can not be changed through access to the parental controls.

7. The method of claim 1, wherein the notification indicates a time when the at least one setting of the parental controls is changed.

8. The method of claim 7, wherein the time indicated in the notification can not be changed through access to the parental controls.

9. The method of claim 1, wherein the access to the parental controls of the apparatus is provided in response to a password input.

10. The method of claim 9, further comprised of providing a second notification to the user in response to a predetermined number of invalid password input attempts.

11. The method of claim 10, wherein the second notification is provided to the user via an electronic mail message.

12. An apparatus having parental controls, comprising:
an input terminal for receiving an input requesting access to the parental controls of the apparatus; and
a processor for providing the access to the parental controls in response to the input, determining whether at least one setting of the parental controls is changed during the access, and providing a notification to a user when at least one setting of the parental controls is changed during the access.

13. The apparatus of claim 12, wherein the notification is provided to the user via an electronic mail message.

14. The apparatus of claim 13, wherein the electronic mail message is sent to a predetermined electronic mail address which can not be changed through access to the parental controls.

15. The apparatus of claim 12, further comprising a memory, wherein the notification is provided via a message stored in the memory which is retrievable by the user.

16. The apparatus of claim 12, wherein the notification indicates a date when the at least one setting of the parental controls is changed.

17. The apparatus of claim 16, wherein the date indicated in the notification can not be changed through access to the parental controls.

18. The apparatus of claim 12, wherein the notification indicates a time when the at least one setting of the parental controls is changed.

19. The apparatus of claim 18, wherein the time indicated in the notification can not be changed through access to the parental controls.

20. The apparatus of claim 12, wherein the input requesting the access to the parental controls is a password.

21. The apparatus of claim 20, wherein the processor provides a second notification to the user in response to a predetermined number of invalid password input attempts.

22. The apparatus of claim 21, wherein the second notification is provided to the user via an electronic mail message.

23. A method for operating an apparatus having parental controls, comprising steps of:
detecting when a rating level corresponding to a reproduction exceeds a rating level corresponding to a parental control setting; and
providing a notification to a user without blocking the reproduction when the rating level corresponding to the reproduction exceeds the rating level corresponding to the parental control setting.

24. The method of claim 23, wherein the notification is provided to the user via an electronic mail message.

25. The method of claim 24, wherein the electronic mail message is sent to a predetermined electronic mail address which can not be changed through access to the parental controls.

26. The method of claim 23, wherein the notification is provided via a message stored in a memory of the apparatus which is retrievable by the user.

27. The method of claim 23, wherein the reproduction is a television program.
